(19) United States
(12) Patent Application Publication
(10) Pub. No.: US 2008/0000315 A1
(43) Pub. Date: Jan. 3, 2008

(54) PARKING LOCK MECHANISM FOR A TRANSMISSION AND TRANSMISSION INCORPORATING SUCH A PARKING LOCK MECHANISM

(75) Inventors: Heinz Reichert, Oberteuringen (DE); Olaf Langwald, Neukirch (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/766,272

(22) Filed: Jun. 21, 2007

(30) Foreign Application Priority Data
Jun. 29, 2006 (DE) 10 2006 030 156.0

(51) Int. Cl. F16H 63/38

(52) U.S. Cl. 74/473.24

(57) ABSTRACT

The present invention relates to a parking lock mechanism (2) for a transmission (1), comprising a pawl (4), which can pivot from a neutral position into a locking position in which the transmission (1) is locked, whereby the pawl (4) is prestressed in the neutral position by way of a spring element. According to the invention, the spring element is a leaf spring (14). The present invention furthermore relates to a transmission (1) incorporating such a parking lock mechanism (2).

This application claims priority from German Application Serial No. DE 10 2006 030 156.0 filed Jun. 29, 2006.

### FIELD OF THE INVENTION

The present invention relates to a parking lock mechanism for a transmission, comprising a pawl, which can pivot from a neutral position into a locking position in which the transmission is locked, whereby the pawl is prestressed in the first position by way of a spring element. Furthermore, the present invention relates to a transmission incorporating such a parking lock mechanism.

### BACKGROUND OF THE INVENTION

From the state of the art, various parking lock mechanisms for automatic transmissions are known. These frequently comprise a pivotable pawl and a parking lock gear wheel, which is located, non-rotatably, on an input shaft of the transmission, the shaft of which is to be locked. The pawl can be pivoted about an axis of rotation from a neutral position in which the pawl does not mesh with the parking lock gear wheel, into a locking position in which the pawl engages the parking lock gear wheel and prevents the output shaft from further rotation. To ensure that the pawl does not mesh permanently with the parking lock gear wheel, the pawl is prestressed in the neutral position by way of a spring element, in known parking lock mechanisms.

DE 197 44 238 A1, for example, describes a parking lock mechanism with a design as described above, wherein a spiral spring with clamp-shaped legs is used as the spring element, so that these legs are also referred to as a leg springs. The spiral-shaped center of the leg spring is located on a pivot pin, about which the pawl of the known mechanism can be pivoted. One leg is supported on the housing of the transmission while the other leg is supported on the pawl.

Also on the parking lock, known from US 2001/0042669 A1, the pawl is prestressed in the neutral position with the aid of a leg spring, the spiral-shaped center of which is located on the axis of rotation of the pawl, while the two legs are supported on the housing and on the pawl. Unlike in the above-described state of the art, however, the legs are straight and not bracket-shaped. Only the leg supported on the pawl has a hook-shaped end to encompass the pawl at least partially. A further parking locking device of this type is also known from DE 199 33 618 A1.

DE 10 2004 052 869 A1 describes another parking brake mechanism according to which the pawl is prestressed in the neutral position with the aid of a torsion spring. Contrary to the above-described parking brake mechanisms, however, the leg, supported on the pawl, is not supported on the edge of the pawl, but rather extends into a recess inside the pawl.

The parking lock mechanisms, known from the state of the art, have proven useful in practice, but have several disadvantages. For example, the known parking locks require a large installation space. Furthermore, the complexity of the spiral or torsion springs, which are also difficult to manage during assembly, can result in faulty assembly, which can ultimately result in a loosening of the spring or torsion spring during operation. Furthermore, the spiral or torsion springs tend to break during operation, which can ultimately lock the transmission permanently. In addition, the measures aimed at preventing the tilting of the pawl, which may occur particularly in the case of axial pawl actuation, result in increased expenses in the known parking lock mechanisms.

It is, therefore, the object of the present invention to create a parking lock mechanism for a transmission, which requires little installation space with which assembly is simplified and which guarantees reliable operation. Furthermore, it is the object of the present invention to create a transmission incorporating such an advantageous parking lock mechanism.

### SUMMARY OF THE INVENTION

The parking lock mechanism for a transmission described in this invention comprises a pawl, which can be pivoted from a neutral position, in which the transmission is not locked into a locking position in which the transmission is locked. This can be accomplished, for example, by way of a detent tooth on the pawl, where the tooth, in the locking position of the pawl meshes, with a corresponding parking lock gear wheel on the output shaft of the transmission. The pawl is prestressed in the neutral position by way of a spring element, known as a leaf spring.

The parking lock mechanism according to the invention has the advantage that the leaf spring, on one hand, is easier to handle than a spiral or tension spring, making assembly easier and preventing faulty assembly and, on the other hand, requires less installation space. The latter can be particularly attributed to the fact that a leaf spring has a very flat design and does not need to be located on the axis of rotation of the pawl nor supported on a housing part.

A preferred configuration of the parking lock mechanism, according to the invention, includes a housing. This can be, for example, a housing of the parking lock mechanism itself or the transmission housing. In this configuration, the leaf spring is attached to the housing. Contrary to the state of the art, the spring element, in the form of the torsion spring, is therefore not attached to the axis of rotation or the pivot pin of the pawl, while the leg of the torsion spring is supported on the housing. Instead, the leaf spring is both attached to and supported on the housing. This has the advantage that installation space is available in the region of the axis of rotation of the pawl, which can be used particularly effectively for further measures to prevent tilting of the pawl.

In another preferred configuration of the parking lock mechanism according to the invention, the leaf spring is attached in a form-fit manner to the housing. The leaf spring can simply be inserted, for example, into an appropriately shaped recess on the housing to achieve the fastening effect. In any case, assembly is considerably easier than with a screw connection or similar.

The above advantage is particularly evident in another preferred configuration of the parking lock mechanism, according to the invention, where the leaf spring has an arched end, which is inserted in a correspondingly arched cavity on the housing to fasten the leaf spring.

In an advantageous configuration of the parking lock mechanism according to the invention, the leaf spring has a free end supported on the pawl. The free end may also be regarded as an end section of the leaf spring.

To ensure that the prestressing force of the leaf spring always acts on a defined region of the pawl regardless of the pivot position of the pawl, according to a particularly preferred configuration of the parking lock mechanism described here, the pawl has a protrusion on which the free end of the leaf spring is supported.

In another advantageous configuration of the parking lock mechanism according to the invention, the protrusion is shaped such that the free end of the leaf spring is always supported on the protrusion at a point or along a line, regardless of the pivot position of the pawl, allowing the prestressing force to act on the pawl with even greater precision.

In order to implement the above configuration, the protrusion has a segment shape in its cross-section in another advantageous configuration of the parking lock mechanism, according to the invention.

In order to be able to apply a prestressing force on the pawl, the leaf spring is supported on one side on the housing and the pawl and on the other side on a stop, such that the pawl is prestressed in the neutral position as in another preferred configuration of the parking lock mechanism according to the invention. The sides referred to here can be interpreted as the opposing sides of the leaf spring.

To keep the number of components and consequently the assembly complexity low in another advantageous configuration of the parking lock mechanism according to the invention, the stop is located on the housing and preferably configured as one piece with the housing. By configuring the stop as one piece with the housing, a predefined configuration of the fastening point of the leaf spring on the housing in relation to the stop is reliably maintained, which ultimately is also a crucial factor for the prestress applied by the leaf spring.

In another advantageous configuration of the parking lock mechanism according to the invention, a parking lock gear wheel is provided. This wheel is non-rotatably connected to the output shaft of the transmission and the pawl, in the locking position, meshes with the parking lock gear wheel.

In another preferred configuration of the parking lock according to the invention, since the leaf spring is very flat, the free end of the leaf spring is supported on the side of the pawl facing the parking lock gear wheel. Despite the tight conditions in this region, the flat leaf spring can be located here, reducing the overall installation space required for the parking lock mechanism.

In another preferred configuration of the parking lock mechanism, according to the invention, the pawl can be pivoted about an axis of rotation, which extends parallel to the output shaft of the transmission to be locked.

According to another advantageous configuration of the parking lock mechanism according to the invention, the axis of rotation is located on the housing. This again produces a defined configuration of the pawl and leaf spring in relation to each other, particularly since the latter is also located on and attached to the housing.

In a particularly preferred configuration of the parking lock mechanism according to the invention, the pawl can be operated in the axial direction in relation to the axis of rotation. During the axial pawl operation, the pawl can easily tilt so that it is advantageous for this embodiment when the spring element or the leaf spring is attached to the housing and not to the axis of rotation. The installation space in the region of the axis of rotation is available for measures aimed at preventing tilting, such as axial guidance for the pawl.

The transmission according to the invention comprises a parking lock mechanism according to the above description.

### BRIEF DESCRIPTION OF THE DRAWING

The invention will now be described, by way of example, with reference to the accompanying drawing in which:

FIG. 1 is a partial front view of a transmission with one configuration of the parking lock mechanism, according to the invention, with the pawl in the neutral position, wherein the transmission is open toward the front, and

FIG. 2 is the transmission, according to FIG. 1, with the pawl in the locking position.

### DETAILED DESCRIPTION OF THE INVENTION

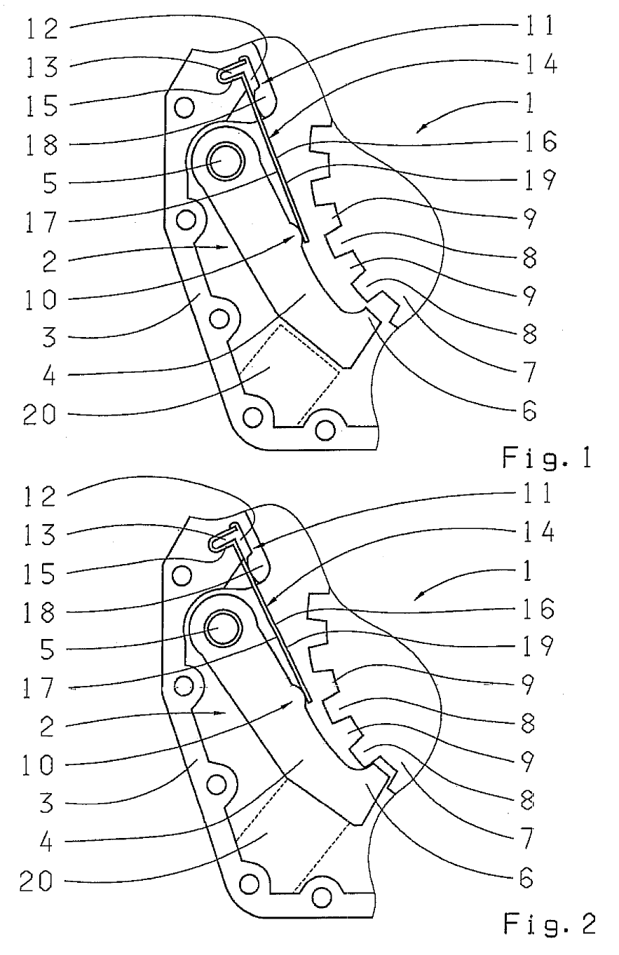

FIG. 1 shows one section of a transmission 1 in which one configuration of the parking lock mechanism 2 according to the invention is incorporated. The transmission 1 comprises a housing 3, which encloses both the transmission components and the parking lock mechanism 2.

The parking lock mechanism 2 first of all comprises a pawl 4, one end of which is connected to an axis of rotation 5 about which the pawl 4 can pivot. The axis of rotation 5 is disposed on the housing 3. On the side of the pawl 4, facing away from the axis of rotation 5, a protruding detent tooth 6 is provided. The detent tooth 6 faces the circumference of a parking lock gear wheel 7, which is non-rotatably connected to the output shaft (not shown) of the transmission 1 and which has on its circumference further detent teeth 8 with detent cavities 9 located between them. The output shaft of the transmission 1 and the axis of rotation 5 of the pawl 4 are arranged parallel to each other. A protrusion 10 is also located on the side of the pawl 4, facing the parking lock gear wheel 7. The protrusion 10 is shaped as a segment of a circle in cross-section and thus a circular arc contour as is apparent from the front view, according to FIG. 1. The function of the protrusion 10 will be addressed in more detail below.

Furthermore, a cavity 11 is located in the housing 3. The housing is shown as being open in FIGS. 1 and 2, as a front housing part has been removed. The cavity 11 is arched so that it has a first section 12, which transitions into a second section 13 disposed at an angle to the first section 12. This can also be referred to as a hook-shaped cavity.

To prestress the pawl 4 in the neutral position, shown according to FIG. 1, the parking lock mechanism 2 also includes a leaf spring 14, which can be made of a strip-shaped, elastic metal part, for example. The leaf spring 14 is attached to the housing 3. For this purpose, the leaf spring 14 has an arched or angled end 15 in relation to the remaining leaf spring 14. With this end inserted into the arched cavity 11, the angled end 15 has a U-shaped. cross-section and accurately fits into the second section 13 of the cavity 11. The angled end 15, on one hand, and the arched cavity 11, on the other hand, create a form-fit attachment of the leaf spring 14 to the housing 3. After attaching the front housing part, which is removed in FIG. 1, the leaf spring 14 can no longer slide laterally out of the cavity 11.

The leaf spring 14 extends from the cavity 11 into the inside of the housing 3, where it is configured as a free end 16. The free end 16 extends in part between the pawl 4 and the parking lock gear wheel 7, whereby the free end 16 is supported on the protrusion 10 of the pawl 4. The leaf spring 14, having a side 17 facing the pawl 4, is thus supported with the side 17 on the protrusion 10, where the shape of the protrusion 10 causes the free end 16 of the leaf spring 14 to be supported on the protrusion 10 always in a line shape, regardless of the pivot position of the pawl 4.

On the housing 3, in the vicinity of the cavity 11, there is also a stop 18 on which a side 19 of the leaf spring 14 facing away from the side 17 of the leaf spring 14 is supported on the protrusion, where the stop 18 is also configured as one piece with the housing 3. Thus, one side 17 of the leaf spring 14 is supported on the housing 3 in the cavity 11 and on the protrusion 10 on the pawl 4, while the other side 19 is influenced in a central area by the stop 18 such that the pawl 4 is prestressed in the neutral position by the leaf spring 14.

The operating principle of the parking lock mechanism 2 will be described below with reference to FIGS. 1 and 2. The pawl 4 is operated with the help of an operating element 20, which is only indicated in the Figures with a dotted line and can be displaced in the axial direction in relation to the axis of rotation 5 of the pawl 4. An operating element 20 of this type is known from DE 199 33 618 A1, for example. Due to the axial displacement of the operating element 20, the pawl 4 abutting the operating element 20 is pivoted about the axis of rotation 5 so that the detent tooth 6 on the pawl 4 meshes with the parking lock gear wheel 7 in that it projects into one of the detent cavities 9. That is, when the parking lock mechanism 2 is in the locking position, as shown in FIG. 2, further rotation of the output shaft of the transmission 1 is prevented. The pawl 4 is pivoted against the force of the leaf spring 14, which undergoes appropriate elastic deflection and which, after pushing the operating element 20 back, effects a return of the pawl 4 into the neutral position, shown according to FIG. 1.

### REFERENCE NUMERALS

1 transmission
2 parking lock mechanism
3 housing
4 pawl
5 axis of rotation
6 detent tooth
7 parking lock gear wheel
8 detent teeth
9 detent cavities
10 projection
11 cavity
12 first section of the cavity
13 second section of the cavity
14 leaf spring
15 arched/angled end of the leaf spring
16 free end of the leaf spring
17 side of the leaf spring
18 stop
19 side of the leaf spring
20 operating element

1-16. (canceled)

17. A parking lock mechanism, for a transmission, comprising:
a pawl (4) which is pivotable from a neutral position into a locking position in which the transmission is locked; and
a leaf spring (14) for biasing the pawl (4) in the neutral position.

18. The parking lock mechanism according to claim 17, wherein the leaf spring (14) is attached to a housing (3).

19. The parking lock mechanism according to claim 18, wherein the leaf spring (14) is attached to the housing (3) in a form-fit manner.

20. The parking lock mechanism according to claim 18, wherein the leaf spring (14) has an arched end (15) which is inserted into a correspondingly arched cavity (11) in the housing (3) for attaching the leaf spring (14) to the housing (3).

21. The parking lock mechanism according to claim 17, wherein the leaf spring (14) has a free end (16) which communicates with and influences the pawl (4).

22. The parking lock mechanism according to claim 21, wherein the pawl (4) has a protrusion (10) which communicates with and is influenced by a free end (16) of the leaf spring (14).

23. The parking lock mechanism according to claim 22, wherein the protrusion (10) is configured such that the free end (16) of the leaf spring (14) always communicates with the protrusion (10) at one of a point and along a line regardless of a pivot position of the pawl (4).

24. The parking lock mechanism according to claim 22, wherein the protrusion (10) has a cross-section having a shape of a segment of a circle.

25. The parking lock mechanism according to claim 17, wherein the leaf spring (14) is supported by the housing (3) and, on one side (17) thereof, engages with the pawl (4) and, on another side (19) thereof, engages with a stop (18) of the housing (3) such that the pawl (4) is prestressed into a neutral position.

26. The parking lock mechanism according to claim 25, wherein the stop (18) is provided on and is integral with the housing (3).

27. The parking lock mechanism according to claim 17, wherein a parking lock gear wheel (7) is non-rotatably connected to a output shaft of the transmission and, when in a locked position, engages the pawl (4).

28. The parking lock mechanism according to claim 27, wherein a free end (16) of the leaf spring (14) communicates with a side of the pawl (4) facing the parking lock gear wheel (7).

29. The parking lock mechanism according to claim 27, wherein the pawl (4) pivots about an axis of rotation (5) which is parallel to the output shaft of the transmission to be locked.

30. The parking lock mechanism according to claim 29, wherein the axis of rotation (5) of the pawl (4) is located on the housing (3).

31. The parking lock mechanism according to claim 29, wherein the pawl (4) is operated in an axial direction in relation to the axis of rotation (5).

32. A transmission having and a parking lock mechanism, and the parking lock mechanism comprises:
a pawl (4) which is pivotable from a neutral position into a locking position in which the transmission is locked; and
a leaf spring (14) for biasing the pawl (4) in the neutral position.

33. A parking lock mechanism, for a transmission, comprising:
a pawl (4) being pivotable, between a neutral position and a locked position, about an axis of rotation (5) that is fixed to a housing (3), and the pawl (4) having a tooth (6) that engages a detent cavity (9) of a parking lock gear wheel (7), when in the locked position, to lock the transmission;
a leaf spring (14) having a first end (15), fixed to the housing (3), and an opposed free end (16) that extends to and communicates with a projection (10) of the pawl (4) such that the leaf spring (14) biases the pawl (4) toward the neutral position; and
an operating element (20) being capable of communicating with the pawl (4) to bias the pawl (4), against a force of the leaf spring (14), such that the tooth (6) of the pawl (4) engages the detent cavity (9) of the parking lock gear wheel (7) when the pawl (4) is in the locked position.
